(19) United States
(12) Patent Application Publication
(10) Pub. No.: US 2025/0121378 A1
(43) Pub. Date: Apr. 17, 2025

(54) METAL REMOVAL UNIT FOR A BULK MATERIAL CONVEYING SYSTEM

(71) Applicant: Dimension Product Solutions LP, Crosby, TX (US)

(72) Inventors: George T. Cook, Crosby, TX (US); Burt Lusk, La Porte, TX (US)

(21) Appl. No.: 18/486,736

(22) Filed: Oct. 13, 2023

(51) Int. Cl. B03C 1/30; B65G 51/02

(52) U.S. Cl. CPC B03C 1/30; B03C 1/284; B03C 1/286; B65G 51/02; B03C 2201/20; B03C 2201/28; B65G 2201/04

(57) ABSTRACT

A metal removal unit for a bulk material conveying system is provided and includes a housing defining an interior space and a magnetic filter assembly movably attached to the housing, the magnetic filter assembly including a plurality of magnetic rods that extend at least partially into the interior space and magnetically attract metal particles in bulk material flowing through the housing.

### BACKGROUND

The present application relates generally to a particulate removal unit for pneumatically conveyed materials, and more particularly, to a metal removal unit for bulk solid materials that are moved by a pneumatic conveying system.

Solid materials such as seeds, grains and granular or powdered materials, are moved between transport vehicles and processing systems. For example, most bulk solid materials are transported by a railcar or truck to a processing plant. Upon arrival at the processing plant, the solid material is commonly moved from the railcar or truck by a pneumatic conveying system.

Pneumatic conveying systems use a series of interconnected pipes that move solid materials long distances by using a combination of pressure and air generated by one or more air blowers connected to the pipes. The amount of pressure generated by each air blower depends on the density of the solid material being moved in the pneumatic conveying system. For example, materials with a high density require a greater air pressure than materials with a low density. Pneumatic conveying systems use positive pressure or negative pressure to move solid materials. A positive pressure pneumatic conveying system generates a positive pressure within the pipes to push solid materials through the pipes. Conversely, a negative pressure conveying system generates negative pressure or a vacuum within the pipes to pull or suck the solid materials through the pipes.

Bulk solid materials commonly have particulate, such as metal, mixed in with the solid materials. The metal particles get into the bulk solid materials through handling, transport or are generated by abrasion that occurs between the solid material and the pipe walls as the solid material moves at high speeds through the metal pipes. Metal contamination in bulk solid materials is harmful if it occurs with solid materials used for food or medicines and can damage equipment or products made with plastic or similar solid materials.

One method of removing metal particles from the bulk solid materials during pneumatic conveying is to attach metal removal equipment to one or more of the pipes in a pneumatic conveying system. Some metal removal equipment use magnets to attract the metal particles while the bulk solid material is moved through the pipes. Periodically, the magnets must be cleaned to remove the metal particles attracted to the magnets. To clean the magnets, the pneumatic conveying system must be shut off temporarily to open the metal removal equipment and remove and clean the magnets. Shutting off the pneumatic conveying system interrupts processing, which leads to significant losses of processing time and money.

Therefore, it is desirable to provide a metal removal unit that effectively and efficiently removes metal from bulk solid materials that are moved by a pneumatic conveying system.

### SUMMARY

The present metal removal unit is attached inline to one or more ducts of a pneumatic conveying system to effectively remove metal contaminants from pneumatically conveyed dry materials.

In an embodiment, a metal removal unit for a bulk material conveying system is provided and includes a housing defining an interior space and a magnetic filter assembly movably attached to the housing, the magnetic filter assembly including a plurality of magnetic rods that extend at least partially into the interior space and magnetically attract metal particles in bulk material flowing through the housing.

In another embodiment, a pneumatic conveying system is provided and includes a duct for conveying bulk materials under positive pressure or negative pressure; and a metal removal unit attached to the duct, wherein the metal removal unit includes a housing and a magnetic filter assembly movably attached to the housing, the magnetic filter assembly including a plurality of magnetic rods that extend at least partially into the interior space and magnetically attract metal particles in bulk material flowing through the duct.

### BRIEF DESCRIPTION OF THE DRAWINGS

FIG. 1 is a perspective view of a rear side of the present metal removal unit.

FIG. 2 is a perspective view of a front side of the metal removal unit of FIG. 1.

FIG. 3 is perspective view of the front side of the metal removal unit with the transparent member removed from the housing.

FIG. 4 is an exploded perspective view of the metal removal unit of FIG. 1.

FIG. 5 is a front perspective view of an embodiment of the magnetic filter assembly.

FIG. 6 is a rear perspective view of the magnetic filter assembly of FIG. 5.

FIG. 7 is an exploded perspective view of the magnetic filter assembly of FIG. 5.

FIG. 8A is a side view of an embodiment of a magnetic rod that is part of the magnetic filter assembly of FIG. 5.

FIG. 8B is a side view of the magnetic rod of FIG. 8A that shows the positions of the magnets and spacers in dashed lines within the magnetic rod.

FIG. 8C is an exploded perspective view of the magnetic rod of FIG. 8A.

### DETAILED DESCRIPTION

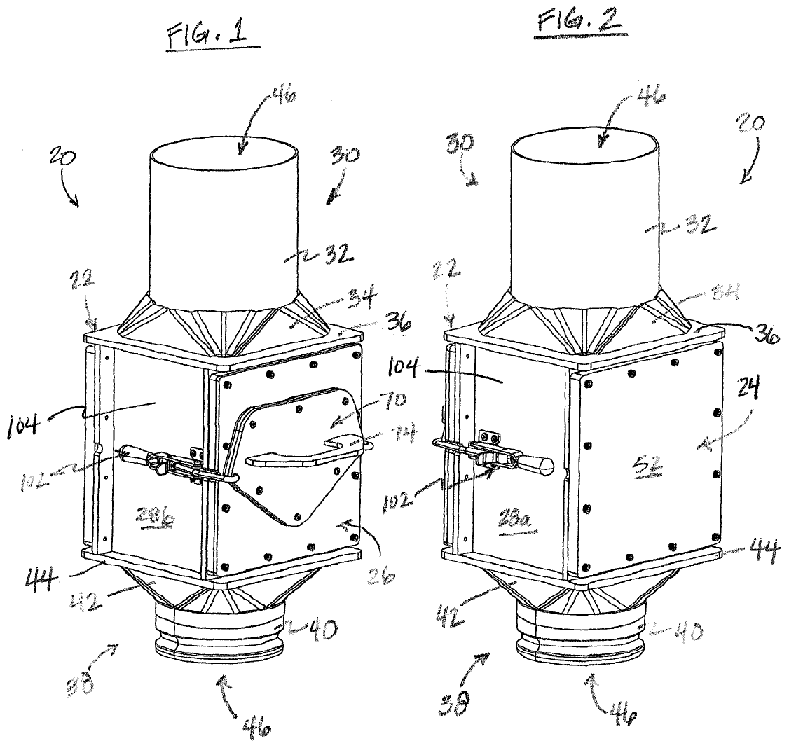

The present metal removal unit is shown in FIG. 1 and generally indicated as 20, where the metal removal unit 20 is attached inline (axially aligned) with one or more ducts or pipes in a pneumatic conveying system. The metal removal unit 20 may be positioned in any orientation, such as horizonatally, vertically or at an angle, that matches the orientation of the duct or pipe that the metal removal unit is being attached to in a pneumatic conveying system. Additionally, the metal removal unit 20 may be installed in positive pressure pneumatic conveying systems and in vacuum or negative pressure pneumatic conveying systems.

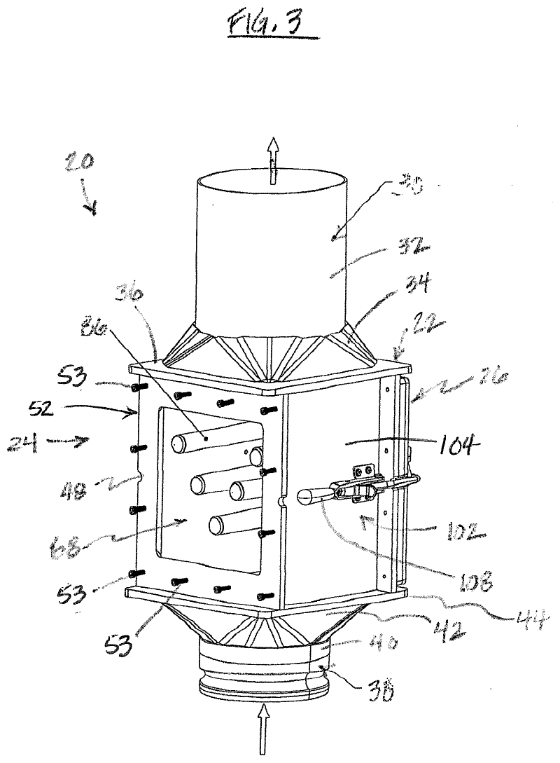

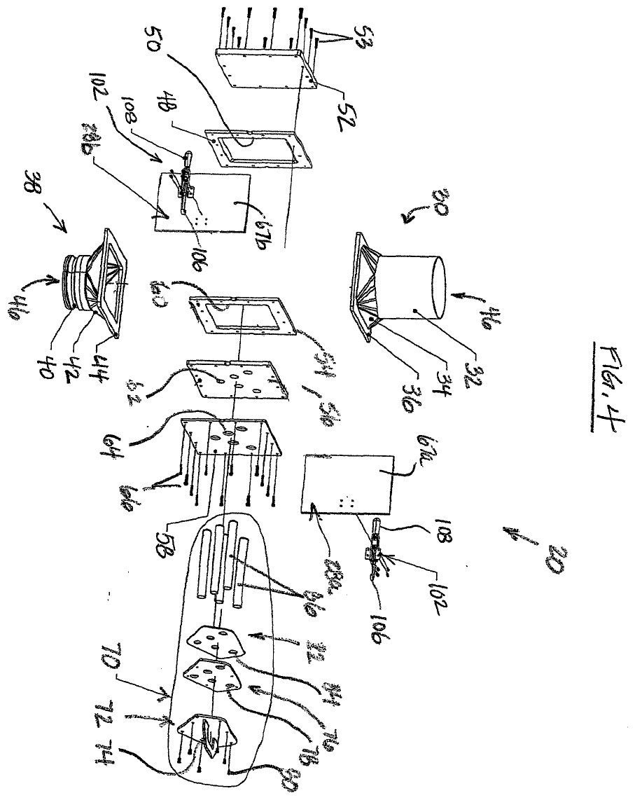

Referring now to FIGS. 1 to 8C, the metal removal unit 20 includes a housing 22 including a front wall 24, a rear wall 26 and opposing sidewalls 28a and 28b extending between the front wall and the rear wall, that are welded together or secured together using fasteners such as bolts or by using any suitable attachment method. An outlet, such as outlet pipe 30, is attached to an end of the housing 22, where the outlet pipe 30 includes a cylindrical body 32 attached to a beveled transition flange 34. A substantially planar connecting flange 36 is attached to the transition flange 34 and also attached to the end of the housing 22 by welding, fasteners or other suitable attachment method. Similarly, an inlet, such as inlet pipe 38, is attached to an opposing end of the housing 22, where the inlet pipe 38 includes a cylindrical body 40 attached to a beveled transition flange 42. A substantially planar connecting flange 44 is attached to the transition flange 42 and also attached to the opposing end of the housing by welding, fasteners or other suitable attachment method. The outlet pipe 30, the transition flange 34 and the flange 36 and the inlet pipe 38, the transition flange 40 and the flange 42, each define a throughhole 46 that extends from a duct or pipe in the pneumatic conveying system to the interior space 68 of the housing 22. In the illustrated embodiment, the outlet pipe 30, the inlet pipe 38, the transition flanges 34, 42 and the flanges 36, 44, are made with metal, such as stainless steel, but may be made with any suitable metal or metal alloy, or any suitable material or combination of materials.

Referring to FIGS. 2 to 4, the front wall 24 of the housing 22 includes a body plate 48 that is generally rectangular and defines a throughhole 50, and a transparent member 52 attached to the body plate 48 by a plurality of fasteners 53 about the perimeter of the transparent member 52. In this embodiment, the transparent member 52 is made with glass, but may be made with plexiglass or any suitable transparent material. In an embodiment, a seal member, such as a rubber gasket (not shown), having the same or similar shape to the body plate 48, is placed between the body plate 48 and the transparent member 52 to form a seal between the body plate and the transparent member. In another embodiment, the side of the body plate 48 facing the transparent member 52 has a seal member or sealing material. During operation of the pneumatic conveying system, the transparent member 52 enables a user to see the interior space of the housing 22 without having to turn off the pneumatic conveying system to access the interior of the housing.

The rear wall 26 on the side of the housing 22, which is opposite to the front wall 24 having the transparent member 52, includes a body plate 54, a wiper plate 56 and a magnet plate 58, where the body plate 54 has generally rectangular shape and defines a throughhole 60. It should be appreciated that the throughhole 50 defined by the body plate 48 of the front wall 24 and the throughhole 60 defined by the body plate 54 of the rear wall 26 may be the same size and shape or a different size and/or shape. As shown, the wiper plate 56 defines five throughholes 62 and is placed against or on the body plate 54, where the throughholes 62 are positioned on the body plate 54 so that the location of the throughholes 62 are within the throughhole 54 of the body plate. Similarly, the magnet plate 58 is placed against or on the wiper plate 56, and defines five throughholes that are aligned with the throughholes 62 on the wiper plate 56. As shown in FIG. 4, the body plate 54, the wiper plate 56 and the magnet plate 58 are secured together by a plurality of fasteners 66 that are positioned about the perimeter of the body plate 54, the wiper plate 56 and the magnet plate 58. In this embodiment, the body plate 54, the wiper plate 56 and the magnet plate 58 are made with a metal, such as stainless steel, but may be made with any suitable metal, metal alloy, or any suitable material or combination of materials.

The opposing sidewalls 28a and 28b each include a side plate 67a, 67b that has a generally rectangular shape and extends between the front wall 24 and the rear wall 26. The side plates 67a, 67b may be welded to the body plates 48, 54 of the front wall 24 and the rear wall 26 or connected to the body plates 48, 54 by fasteners or by any suitable attachment method. After assembly, the front wall 24, the rear wall 26 and the sidewalls 28a, 28b define an interior space 68 that is in fluid communication with the throughholes 46 of the outlet pipe 30 and the inlet pipe 38.

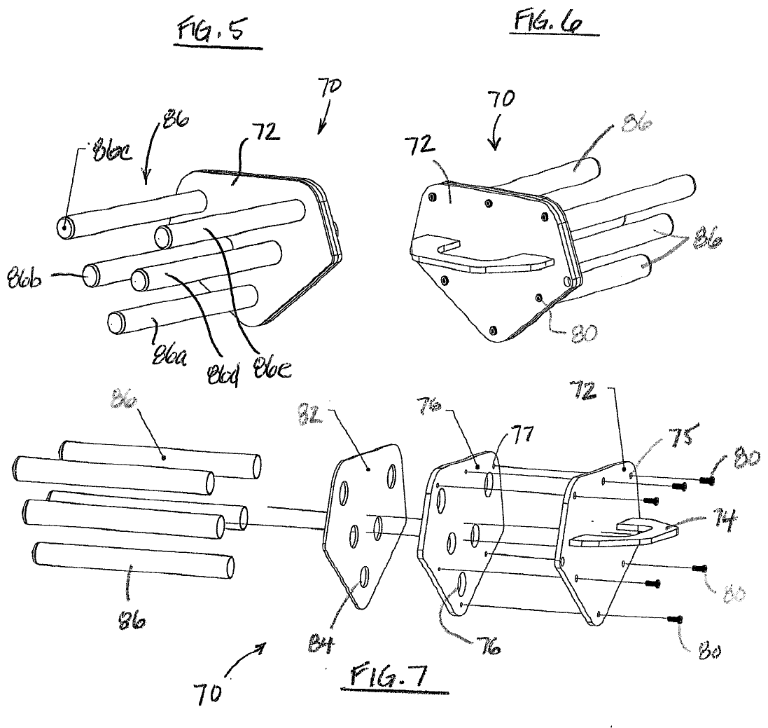

Referring to FIGS. 4 to 8C, a magnetic filter assembly 70 is movably attached to the rear wall 26. Specifically, the magnetic filter assembly 70 includes a cover plate 72 having a handle 74 and throughholes 75, where the cover plate 72 has a polygonal shape. It should be appreciated that the cover plate 72 may be any suitable size and shape. A base plate 76 having five throughholes 78 is placed on the cover plate 72, where the base plate 76 is substantially the same size and shape as the cover plate 72. A plurality of fasteners 80 are positioned about the perimeter of the cover plate 72 and are inserted through the throughholes 80 in the cover plate and into corresponding throughholes 77 in the base plate 76 to secure the cover plate to the base plate 76. As shown in FIG. 7, a seal member, such as gasket 82, having five throughholes 84 that are aligned with the throughholes 78 on the base plate 76, is placed on the base plate. In an embodiment, the gasket 82 is secured to the base plate 76 using a suitable sealant or adhesive. A plurality of magnetic rods 86 are inserted through the throughholes 84 in the gasket 82 and the base plate 76 until the ends of the magnetic rods abut a surface of the cover plate 72. In the illustrated embodiment, the magnetic filter assembly 70 includes five magnetic rods 86 arranged in a v-shaped pattern. It should be appreciated that the magnetic filter assembly 70 may have any suitable number of the magnetic rods 86 and arranged in any suitable pattern. During assembly, the magnetic rods 86 are attached to the base plate 76, the cover plate 72 or both the base plate 76 and the cover plate 72 by welding, by friction fit or using any suitable attachment method.

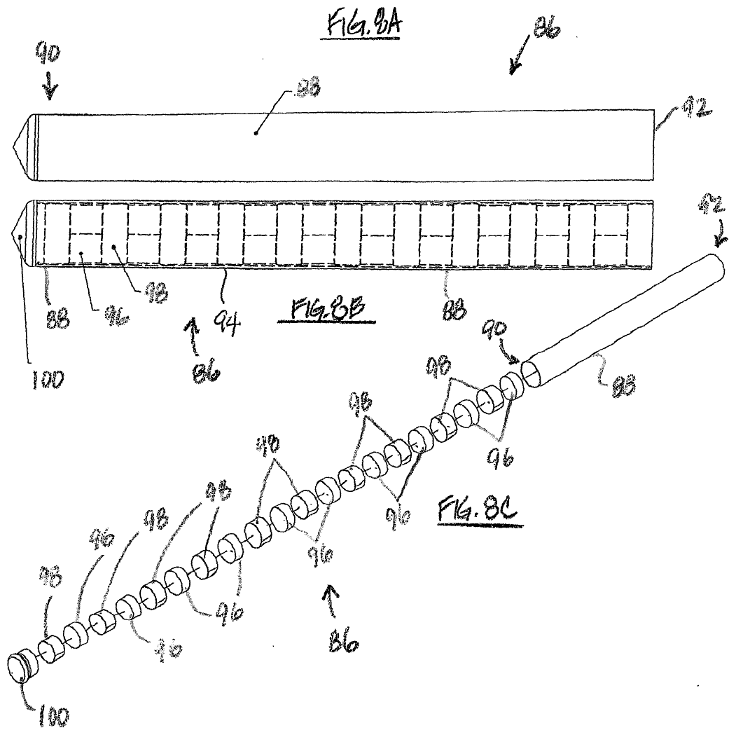

Referring to FIGS. 8A, 8B and 8C, each of the magnetic rods 86 includes a cylindrical housing 88 having an open end 90 and a closed end 92, and defining an interior space 94. A plurality of magnets 96 are placed in the interior space 94 and are separated by a plurality of spacers 98 as shown in FIG. 8B. In this embodiment, the magnets 96 are neodymium magnets and the spacers 98 are made of carbon steel. It should be appreciated that the magnets 96 may be any suitable magnet or made with any suitable magnetic material, and the spacers 98 may be made with any suitable material or combination of materials. In the illustrated embodiment, each of the magnetic rods 86 includes ten magnets 96 and ten spacers 98, but may include different numbers of magnets and spacers. The strength of the magnetic attraction produced by each of the magnetic rods 86 depends on the number of magnets and magnetic power of the magnets inserted in the housing of each magnetic rod. It should be appreciated that the magnetic strength of each magnetic rod 86 in the magnetic filter assembly 70 may be the same or the magnetic power of one or more of the magnetic rods 86 may be different. After the magnets 96 and spacers 98 are inserted into the magnetic rods 86, the open end 90 of each magnetic rod 86 is sealed by an end cap 100 having a conical outer surface 102. The end cap 100 may be removably connected to the open end 90 of each magnetic rod 86 using a threaded connection or another suitable connection method that enables the end cap 100 to be removed from the housing 88. In use, the end caps 100 may be removed so that one or more of the magnets 96 may be removed and replaced as needed.

The magnetic filter assembly 70 is movably attached to the housing 22 by aligning the magnetic rods 86 with the throughholes 64 on the magnet plate 58 and the throughholes 62 of the wiper plate 56 and applying pressure to the cover plate 72 to move the magnetic rods 86 through the magnet plate 58 and the wiper plate 56 until the cover plate 72 of the magnetic filter assembly 70 abuts the magnet plate 58 and the magnetic rods 86 at least partially extend into the interior space 68 of the housing 22. It should be appreciated that the magnetic rods 86 each have a length where the lengths of the magnetic rods are the same or where one or more of the magnetic rods 86 may have the same length or different lengths.

As shown in FIGS. 1 and 4, the sidewalls 28a, 28b each include a latch 102 secured to an outer surface 104 of the side plates 67a, 67b, where each latch includes a hook member 106 and a pivoting handle 108. After the magnetic filter assembly 70 is fully inserted into the housing 22, the hook member 106 of each latch 102 is positioned against the outer surface of the cover plate 72 and the handle 108 is pivoted from an open position away from the housing 22 to a closed position against the housing 22, which pulls the hook members 106 against opposing sides of the outer surface of the cover plate 72 and applies tension to the cover plate 72 so that the magnetic filter assembly 70 is sealed against the outer surface of the rear wall 36 of the housing 22. To move or remove the magnetic filter assembly 70 from the housing 22, the handles 108 on the latches 102 are both pivoted away from the housing 22 to the open position, which releases tension on the cover plate 72 and enables the hook members 106 to be moved away from the cover plate 72. A user may then grasp the handle 74 and pull the magnetic filter assembly 70 so that it moves outwardly from the housing 22.

In operation, the metal removal unit 20 is installed inline with one or more ducts or pipes in a pneumatic conveying system that transport bulk dry materials from railcars or other vehicles to a processing system, between process machines in the processing system or to any location that the bulk dry materials are used or stored. Specifically, the outlet pipe 30 and the inlet pipe 38 are attached to corresponding ducts or pipes in the pneumatic conveying system by welding, fasteners or another suitable attachment method. During the pneumatic conveying process, metal contaminants such as metal particles that are commonly found in bulk dry materials being conveyed, are magnetically attracted to the magnetic rods 86 of the magnetic filter assembly 70 as the bulk dry material passes through the metal removal unit 20. When the magnetic rods 86 are sufficiently covered with the metal particles, the pneumatic conveying system is turned off, and the latches 102 on the sidewalls 28a, 28b of the housing 22 are moved to the open position as described above. Next, a user grasps the handle 74 on the magnetic filter assembly 70 and pulls it outwardly away from the housing 22. The wiper plate 56 removes some of the magnetic particles from the outer surfaces of the magnetic rods 86 as the magnetic rods 86 move through the throughholes 62 of the wiper plate 56 when the magnetic filter assembly 70 is being moved outwardly from the housing 22. The removed particles fall into a basket or compartment attached to the metal removal unit and removed or the metal particles are removed by hand from the metal removal unit. Any metal particles remaining on the magnetic rods 86 are removed by hand using a cloth or other suitable removal method. After the magnetic rods 86 are cleaned, i.e., after the metal particles are removed from the outer surfaces of the magnetic rods, the magnetic filter assembly 70 is pushed inwardly into the housing 22 until the cover plate 72 contacts the housing 22. The latches 102 are then moved to the closed position so that the hook members 106 apply tension to the opposing sides of the cover plate 72 to sealingly engage the magnetic filter assembly 70 with the housing 22.

In the above embodiment, the arrangement of the magnetic rods 86 in the magnetic filter assembly 70 forms a v-shaped pattern where one magnetic rod 86a is positioned in a central area of the base plate 76 and two sets of magnetic rods 86b, 86c and 86d, 86e are spaced from the magnetic rod 86a at an angle on both sides of the magnetic rod 86a. Specifically, magnetic rods 86b and 86c are positioned on an angle relative to the magnetic rod 86a a on a first side of the magnetic rod and magnetic rods 86d, 86e are positioned at an angle from an opposing second side of the magnetic rod 86a. In an example embodiment, the v-shaped pattern of the magnetic rods 86 is formed by spacing the magnetic rods 1.0 inch horizontally from center (or from a longitudinal axis extending through magnetic rod 86a) and 1.0 inch vertically from the magnetic rod 86a, and spacing the magnetic rods 86d and 86e 2.0 inches horizontally from center and 1.0 inch vertically from the centers of the magnetic rods 86b and 86c. It should be appreciated that the magnetic filter assembly 70 may have any suitable number of magnetic rods 86 having any size and shape, and the magnetic rods may be arranged in any suitable pattern.

This arrangement of the magnetic rods 86 helps to minimize disruption of the flow of the bulk material through the metal removal unit 20 as well as evenly spreads the bulk material over the magnetic rods 86 as the bulk material flows through the metal removal unit 20 to effectively filter the metal particles from the bulk material. Also, the arrangement of the magnetic rods 86 maintains “voids” or spaces behind the magnetic rods to trap the metal particles and other contaminants so that the trapped metal particles and other contaminants do not re-enter the flow of the bulk material.

In the above embodiment, the transparent member 52 on the front wall 24 of the housing 22 enables a user to directly, visually inspect the interior of the metal removal unit and more specifically, the magnetic rods 86, without having to shut off the pneumatic conveying system and disrupt the operation of the processing system. In this way, the magnetic rods 86 in the magnetic filter assembly 70 are inspected during the operation of the pneumatic conveying system, which provides instant information on the types and amount of metal contaminants in the bulk material being conveyed, the source or sources of the metal contaminants, for example, which railcar or vehicle includes the bulk material with metal contaminants, and helps to reduce downtime due to manually opening the metal removal unit 20 to inspect the magnetic rods 86, which reduces efficiency and increases processing costs.

While particular embodiments of the present metal removal unit are shown and described, it will be appreciated by those skilled in the art that changes and modifications may be made thereto without departing from the invention in its broader aspects and as set forth in the following claims.

1. A metal removal unit for a bulk material conveying system, the metal removal unit comprising:
a housing defining an interior space;
a magnetic filter assembly movably attached to said housing, said magnetic filter assembly including a plurality of magnetic rods that extend at least partially into said interior space and magnetically attract metal particles in bulk material flowing through the housing; and
a wiper plate fixedly attached to a wall of said housing, said wiper plate having a plurality of throughholes corresponding to said plurality of magnetic rods of said magnetic filter assembly, wherein said wiper plate removes metal attracted to said magnetic rods as said magnetic rods move outwardly from said housing when said magnetic filter assembly is removed from said housing so that the metal removed from said magnetic rods remains inside said housing.

2. The metal removal unit of claim 1, wherein the magnetic rods are arranged in a v-shaped pattern.

3. The metal removal unit of claim 1, wherein the magnetic filter assembly includes a base plate attached to a cover plate having a handle, the base plate defining a plurality of throughholes configured to receive and secure the plurality of magnetic rods.

4. The metal removal unit of claim 3, further comprising a seal member defining throughholes that align with the throughholes of the base plate, wherein said seal member forms a seal between the magnetic filter assembly and the housing.

5. The metal removal unit of claim 1, wherein said housing includes a transparent member that enables a user to visually see into the interior space of said housing.

6. The metal removal unit of claim 1, further comprising at least one latch mounted on the housing, wherein said at least one latch includes a hook member and a handle, and wherein said hook member engages and applied tension to said magnetic filter assembly when said handle is moved to a closed position, and disengages said magnetic filter assembly when said handle is moved to an open position.

7. The metal removal unit of claim 1, further comprising an inlet pipe attached to a first end of said housing, and an outlet pipe attached to an opposing, second end of said housing, said inlet pipe and said outlet pipe each defining throughholes that are in fluid communication with said interior space of said housing.

8. The metal removal unit of claim 1, wherein each of said magnetic rods includes a housing having an open end and defining an interior space, a plurality of magnets inserted into said interior space and a plurality of spacers, wherein said magnets and said spacers are alternately positioned in said interior space.

9. A pneumatic conveying system comprising:
a duct for conveying bulk materials under positive pressure or negative pressure; and
a metal removal unit attached to said duct, wherein said metal removal unit includes:
a housing defining an interior space;
a magnetic filter assembly movably attached to said housing, said magnetic filter assembly including a plurality of magnetic rods that extend at least partially into said interior space and magnetically attract metal particles in bulk material flowing through the duct; and
a wiper plate fixedly attached to a wall of said housing, said wiper plate having a plurality of throughholes corresponding to said plurality of magnetic rods of said magnetic filter assembly, wherein said wiper plate removes metal attracted to said magnetic rods as said magnetic rods move outwardly from said housing when said magnetic filter assembly is removed from said housing so that the metal removed from said magnetic rods remains inside said housing.

10. The pneumatic conveying system of claim 9, wherein the magnetic rods are arranged in a v-shaped pattern.

11. The pneumatic conveying system of claim 9, wherein the magnetic filter assembly includes a base plate attached to a cover plate having a handle, the base plate defining a plurality of throughholes configured to receive and secure the plurality of magnetic rods.

12. The pneumatic conveying system of claim 11, further comprising a seal member defining throughholes that align with the throughholes of the base plate, wherein said seal member forms a seal between the magnetic filter assembly and the housing.

13. The pneumatic conveying system of claim 9, wherein said housing includes a transparent member that enables a user to visually see into the interior space of said housing.

14. The pneumatic conveying system of claim 9, further comprising at least one latch mounted on the housing, wherein said at least one latch includes a hook member and a handle, and wherein said hook member engages and applied tension to said magnetic filter assembly when said handle is moved to a closed position, and disengages said magnetic filter assembly when said handle is moved to an open position.

15. The pneumatic conveying system of claim 9, further comprising an inlet pipe attached to a first end of said housing, and an outlet pipe attached to an opposing, second end of said housing, said inlet pipe and said outlet pipe each defining throughholes that are in fluid communication with said interior space of said housing.

16. The pneumatic conveying system of claim 9, wherein each of said magnetic rods includes a housing having an open end and defining an interior space, a plurality of magnets inserted into said interior space and a plurality of spacers, wherein said magnets and said spacers are alternately positioned in said interior space.
